(19) United States
(12) Patent Application Publication
(10) Pub. No.: US 2018/0253852 A1
(43) Pub. Date: Sep. 6, 2018

(54) METHOD AND DEVICE FOR LOCATING IMAGE EDGE IN NATURAL BACKGROUND

(71) Applicants: BEIJING QIHOO TECHNOLOGY COMPANY LIMITED, BEIJING (CN); QIZHI SOFTWARE (BEIJING) COMPANY LIMITED, BEIJING (CN)

(72) Inventors: WANG ZHANG, BEIJING (CN); YU TANG, BEIJING (CN); XUEKAN QIU, BEIJING (CN)

(73) Assignees: BEIJING QIHOO TECHOLOGY COMPANY LIMITED, BEIJING (CN); QIZHI SOFTWARE (BEIJING) COMPANY LIMITED, BEIJING (CN)

(21) Appl. No.: 15/740,439

(22) PCT Filed: Nov. 7, 2016
(86) PCT No.: PCT/CN2016/104935

§ 371 Date: Dec. 28, 2017

(30) Foreign Application Priority Data
Nov. 25, 2015 (CN) 201510834973.X

(51) Int. Cl. G06T 7/13; G06T 7/12; G06T 7/90

(52) U.S. Cl. CPC G06T 7/13; G06T 7/90; G06T 7/12

(57) ABSTRACT

The disclosure discloses a method and device for locating an image edge in a natural background. The method comprises: extracting a central color feature serving as a comparison standard for an image located in a natural background; comparing with the central color feature, and extracting multiple candidate points for each edge of the image according to a comparison result; grouping the multiple candidate points corresponding to the edge according to a distance and/or a direction, so as to obtain multiple candidate point groups; fitting a corresponding fit line by using a candidate point in each candidate point group; and selecting a fit line close to most candidate points of the edge, and locating the fit line as the edge.

### CROSS REFERENCE TO RELATED APPLICATIONS

This application is national stage application of PCT/CN2016/104935 filed Nov. 7, 2016, and is based upon and claims priority to Chinese Patent Application No. 201510834973.X, filed in China on Nov. 25, 2015, the entire contents of which are incorporated herein by reference.

### TECHNICAL FIELD

The present invention relates to the technical field of computer and particularly to a method and a device for locating an image edge in a natural background.

### BACKGROUD

In real life and at work, information in certain images with frames in a picture or a video needs to be acquired, such as information on a business card or information on a tag, etc. When acquiring such information, a terminal device needs to locate the image edge first, that is, detect the edge thereof.

The traditional image edge detection methods generally adopt methods such as Hough transformation or significance detection, etc.

In the Hough transformation, the point—line duality of the image space and the Hough parameter space is employed to transform the detection in the image space into the parameter space. When such method is adopted to detect the image edge, it needs to map each point into a curved surface of the parameter space, which is one to many mapping, such that the amount of computation is large, resulting in slower detection rate. Furthermore, when the image is disturbed by outside noise, the signal to noise ratio is low and in this case, the performance of the conventional Hough transformation will be drastically reduced, resulting in low accuracy of the acquired image edge.

If the method of significant detection is adopted, the method relies on the consistency of the background, so that the interference of the background is too large and in the meantime the information of the image edge itself may be easily ignored, resulting in low accuracy of the acquired image edge.

At present, there is no more accurate method for locating the image edge.

### SUMMARY

In view of the above problem, the present invention is proposed to provide a device for locating an image edge in a natural background and a corresponding method for locating the image edge in the natural background for overcoming or at least partly solving or alleviating the above problem.

Based on an aspect of the present invention, a method for locating an image edge in a natural background is provided, comprises:

extracting a central color feature serving as a comparison standard for an image located in a natural background;

comparing with the central color feature and extracting multiple candidate points for each edge of the image according to a comparison result;

grouping the multiple candidate points corresponding to the edge according to distances and/or directions, so as to obtain multiple candidate point groups;

fitting corresponding fit lines by using the candidate points in each candidate point group;

selecting a fit line closest to the candidate points of the edge and locating the fit line as the edge.

Based on another aspect of the present invention, a device for locating an image edge in a natural background is provided, comprises:

an extracting module adapted for extracting a central color feature serving as a comparison standard for an image located in a natural background;

a comparing module adapted for comparing with the central color feature and extracting multiple candidate points for each edge of the image according to a comparison result;

a grouping module adapted for performing the following operation for each edge: grouping the multiple candidate points corresponding to the edge according to distances and/or directions, so as to obtain multiple candidate point groups;

a fitting module adapted for, for each edge, fitting corresponding fit lines by using the candidate points in each candidate point group;

a locating module adapted for, for each edge, selecting a fit line closest to the candidate points of the edge and locating the fit line as the edge.

Based on further another aspect of the present invention, a computer program is provided, comprising a computer readable code, which, when the computer readable code is running on a computing device, causes the computing device execute the above described method for locating the image edge in the natural background.

Based on yet another aspect of the present invention, a computer readable medium is provided, in which the above described computer program is stored.

The beneficial effect of the present invention is as follows:

According to the method in an embodiment of the present invention, the central color feature of an image is extracted as a comparison standard. Due to the centrality of the central color feature, the relation of each edge to the center is made relatively comply with the average, for example, the distance or the direction from a comparison feature point to each edge is more consistent, so that the obtained candidate points of each edge maintain smoothness, candidate points with larger error will not occur easily, and the influence of the natural background on the central color feature can be avoided as much as possible. For example, if the comparison feature points are close to a certain edge and the color of the natural background near the edge is close to the color of the comparison feature points, it easily leads to blurred lines. Therefore, by using the central color feature, the natural background and the image can be divided as much as possible, multiple kinds of disturbances of the natural background (such as color disturbance or noise disturbance) can be avoided, and the accuracy of the image edge location can be improved. In addition, by extracting the candidate points by comparing with the central line color feature, in comparison with the traditional edge detection method, the amount of the computation of the executive body is reduced and the speed of the image edge location is increased. By grouping the multiple candidate points corresponding to the edge according to the distance and/or the direction, the candidate points, which are distributed dispersedly, present a certain regularity, and according to the presented regularity, it is beneficial to fitting of a fit line corresponding to the edge, to improve the quality of the candidate fit line and further to increase the accuracy of the image edge location.

The above explanation is merely an overview of the technical solutions of the present invention. In order to be able to understand more clearly and embody the technical means of the present invention in accordance with the contents of the description, and in order to make the above and other objectives, features and advantages of the present invention more obvious and understandable, specific embodiments of the present invention are described below.

### BRIEF DESCRIPTION OF THE DRAWINGS

By reading the detailed description of the preferred embodiments below, various other advantages and benefits become clear for a person of ordinary skill in the art. The drawings are only used for the purpose of showing the preferred embodiments and are not intended to limit the present invention. And in the whole drawings, same drawing reference signs are used for representing same components. In the drawings:

FIG. 1 schematically shows a schematic diagram of a process flow of a method for locating an image edge in a natural background according to an embodiment of the present invention;

FIG. 2 schematically shows a schematic diagram of a model for extracting a central color feature of the image in the natural background according to an embodiment of the present invention;

FIG. 3 schematically shows a schematic diagram of the image in the natural background according to an embodiment of the present invention;

FIG. 4 schematically shows a schematic diagram of a feature comparison template provided for an edge of the image according to an embodiment of the present invention;

FIG. 5 schematically shows a schematic diagram of edge operators of 8 directions with widths provided for edges of a rectangular image according to an embodiment of the present invention;

FIG. 6 schematically shows a schematic diagram of a model for computing a two dimensional confidence of an edge point according to an embodiment of the present invention;

FIG. 7 schematically shows a schematic diagram of a process flow of a method for locating the image edge of a Life VC tag according to an embodiment of the present invention;

FIG. 8 schematically shows a schematic diagram of a structure of a device for locating an image edge in a natural background according to an embodiment of the present invention;

FIG. 9 schematically shows a schematic diagram of another structure of a device for locating an image edge in a natural background according to an embodiment of the present invention;

FIG. 10 schematically shows a block diagram of a computing device for executing the method for locating the image edge in the natural background according to the present invention; and

FIG. 11 schematically shows a storage unit for holding or carrying a computer code for realizing the method for locating the image edge in the natural background according to the present invention.

### DETAILED DESCRIPTION

Hereinafter, the present invention will be further described in connection with the companying drawings and specific embodiments. To solve the above described technical problem, in an embodiment of the present invention, a method for locating an image edge in a natural background is provided. FIG. 1 shows a schematic diagram of a process flow of the method for locating the image edge in the natural background according to an embodiment of the present invention. With reference to FIG. 1, the method at least includes the following steps S102 to S110.

First of all, in an embodiment of the present invention, a step S102 is performed of extracting a central color feature serving as a comparison standard for an image located in a natural background.

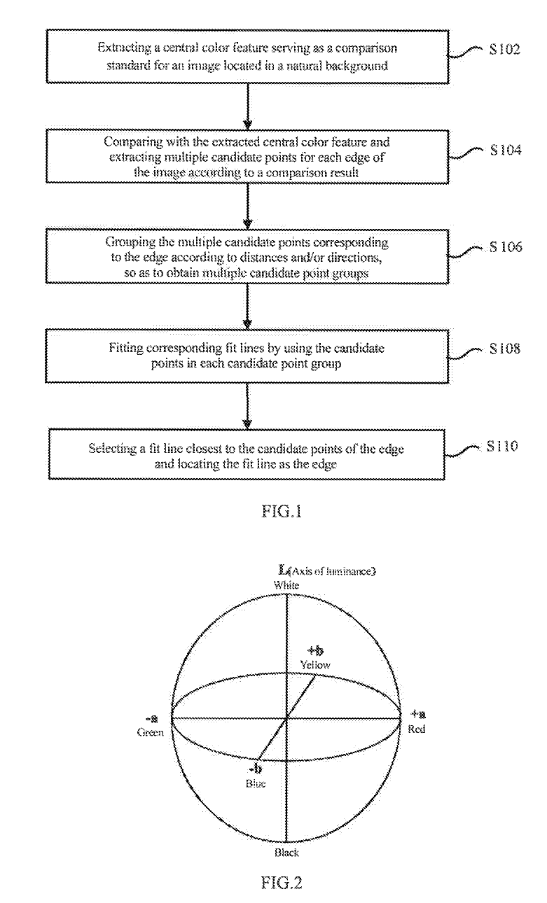

Specifically, FIG. 2 shows a schematic diagram of a model for extracting the central color feature of the image in the natural background according to an embodiment of the present invention. The schematic diagram of the model includes three coordinate axes of a, b, L, with L representing the luminance of the image for candidate edge detection, (a, b) representing the color of the image for foreground modeling and similarity analysis. With reference to FIG. 2, the color at the limit of the positive direction of the L axis is white, the color at the limit of the negative direction of the L axis is black, the color at the limit of the positive direction of the a axis is red, the color at the limit of the negative direction of the a axis is green, the color at the limit of the positive direction of the b axis is yellow and the color at the limit of the negative direction of the b axis is blue. In the embodiment of the present invention, the extraction of the central color feature is performed according to the luminance L and the color (a, b) of the image as three dimensions. Specifically, after scanning the image by using a camera, the central position of the image is detected first, then relevant information on the color of the central position of the image is acquired, the relevant information on the color is input into the model shown in FIG. 2 and a central color feature value of the image will be obtained according to the model.

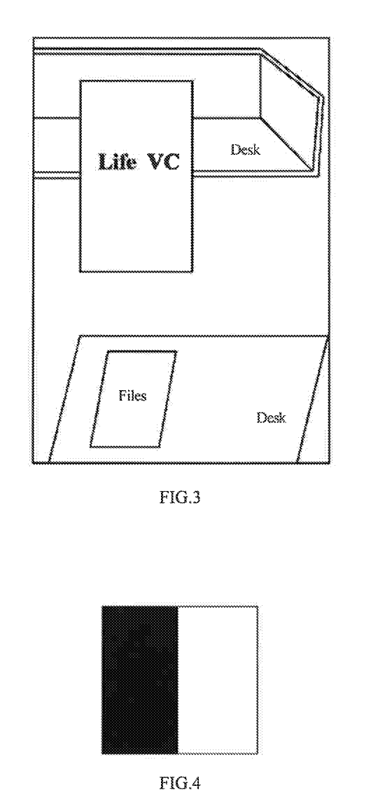

In an embodiment of the present invention, a specific example is provided for setting forth the extraction process of the central color feature. FIG. 3 shows a schematic diagram of the image in the natural background according to an embodiment of the present invention. In the present example, scanning is performed locally by using a camera, a Life VC tag is the image located in the natural background in the picture and the natural background is objects behind the tag such as the desk body, files placed on the desktop and etc. By using the model for extracting the central color feature shown in FIG. 2, the central color feature of the Life VC tag is extracted and the extraction result is a central color feature value (a: 0, b: 0, L: 69). In the embodiment of the present invention, the central color feature of the image is extracted as a comparison standard. The centrality of the central color feature makes the relation of each edge to the center relatively comply with the average, so that the candidate points of each edge obtained below according to comparison with the central color feature maintain smoothness and candidate points with larger error will not occur easily. If a color feature of another position is used as the comparison standard, due to inconsistent distance and direction from each edge to the comparison feature point, a case will emerge in which the candidate points of each edge obtained by comparison may have larger errors. Further, due to the centrality of the central color feature in the image, the influence of the natural background on the central color feature can be avoided as much as possible. For example, if the comparison feature points are close to a certain edge and the color of the natural background near the edge is close to the color of the comparison feature point, it easily leads to blurred lines. Therefore, by using the central color feature, the natural background and the image can be divided as much as possible, multiple kinds of disturbances of the natural background (such as color disturbance or noise disturbance) can be avoided, and the accuracy of the image edge location can be improved.

It should be noted that, in the embodiment of the present invention, the Life VC tag shown in FIG. 3 is used as a specific example, by which the protection scope of the embodiment of the present invention should not limited. In actual applications, the embodiment of the present invention is applicable to any image with an edge, such as round, square, trapezoidal, irregular graphics etc.

After the end of the performance of the step S102, a step S104 is further performed of acquiring a comparison result by comparing with the central color feature extracted in the step S102. Further, multiple candidate points are extracted for each edge of the image according to the acquired comparison result. In comparison with the traditional detection method, in the embodiment of the present invention, the candidate points are extraction by using the comparison with the central color feature, which, for an executive body, occupies less work resources, reduces the amount of computation and increase the speed of the image edge location.

Therein, extraction of multiple candidate points for each edge includes a plurality of algorithms and a preferable algorithm is provided in the embodiment of the present invention, that is, the extraction of the candidate points is performed by way of convolution. It should be noted that, convolution is a linear operation, by which a mathematical operator of a third function is generated by two functions, such as mask operation which applies to image filtering. In an embodiment of the present invention, a third function is generated by convolution of both functions of a feature comparison template and the image and the output value of the third function is a grayscale value of a point in the image. For example, a certain specific point in the image is selected and a relevant value corresponding to the point is input into the third function and the grayscale value of the point will be obtained. Then the grayscale value of the point is compared with the central color feature value and the candidate points are extracted according to the comparison result.

Specifically, the extraction of the candidate points at least includes the following steps:

a step 1 of providing feature comparison templates for each edge of the image;

a step 2 of performing convolution with the image by using the feature comparison templates of any edge and comparing the grayscale value obtained by convolution with the central color feature to obtain a comparison result;

a step 3 of selecting and extracting a point in the comparison result, the grayscale value of which exceeds the central color feature, as a candidate point.

Specifically, the image in the natural background includes at least one edge and a corresponding feature comparison template is provided for each edge of the image. For example, the image of the Life VC tag in FIG. 3 includes 4 edges up, down, left and right. A corresponding feature comparison template is provided for the left edge of the image and accordingly corresponding feature comparison templates are provided for the right edge, the upper edge and the lower edge of the image, respectively.

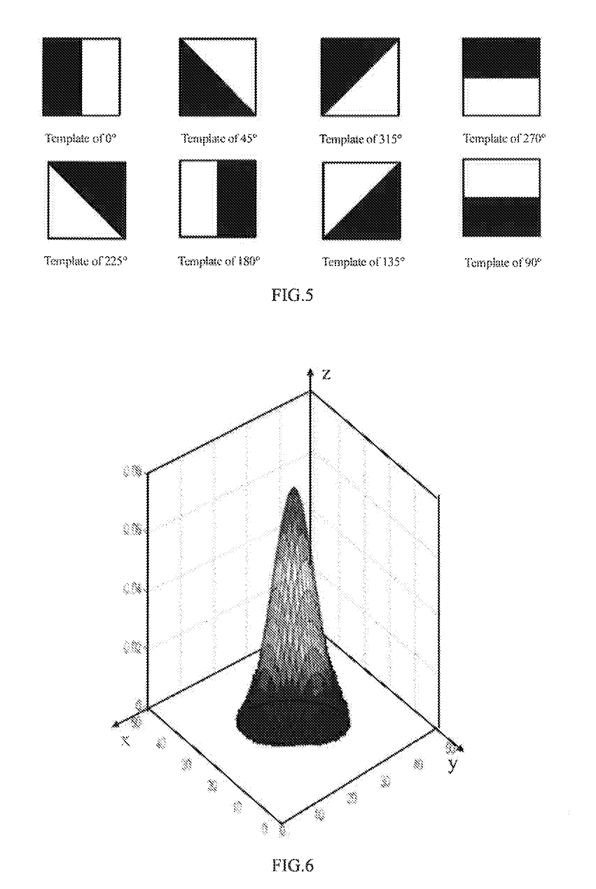

In a preferable embodiment of the present invention, the provided feature comparison templates are edge operators with width. FIG. 4 shows a schematic diagram of the feature comparison template provided for the edge of the image according to an embodiment of the present invention. The feature comparison template provided in FIG. 4 is an edge operator with width. It should be noted that, the width of the edge operator of any value can be selected, for example, an edge operator with width of 11*11 may be selected. Furthermore, the edge operator can be provided with regions with different luminance. In FIG. 4, one dark region and one light region are shown. In accordance with actual needs, the edge operator can also be provided with a region with progressive luminance and etc.

Because the edge operator in the embodiment of the present invention is a square region with width, the region detected by using the edge operator, in which the candidate points are aggregated, is also with width and the width is about half width of the edge operator, so that the extracted candidate points are more aggregated, which is beneficial to the candidate points presenting a certain regularity, and thus results in the edge generated according to this regularity having good aggregation and continuity. Further, by using the edge operator for the image edge detection, if most of the pixels in the image meet requirement for luminance difference of the edge operator, the point can be used as a candidate point of the edge. If a single pixel emerges which meets the requirement for luminance difference, the point is a noise point. Therefore, by using an edge operator with width to detect the edge of the image, the isolated noise point will be eliminated and the disturbance by a noise point similar to an edge will be avoided, which increases the accuracy of the image edge detection.

It should be noted that, FIG. 4 merely shows a schematic diagram of one feature comparison template and such feature comparison template is not completely applicable to arbitrary shaped edge of an image. Therefore, feature comparison templates of other types are also included, from which a feature comparison template applicable to each edge of the image can be selected, such as a multi-angle edge operator, which can be used for the image edge detection for the image with round, trapezoidal or irregularly shaped edges.

Preferably, if the image in the natural background is a rectangle, edge operators of 8 directions with widths are provided for the image, in which edge operators of every two adjacent directions in combination are used for detecting one edge of the rectangle image. FIG. 5 shows a schematic diagram of edge operators of 8 directions with widths provided for edges of a rectangular image according to an embodiment of the present invention, in which a template of 0° and a template of 45° are used for detecting the left edge of the rectangle image, a template of 315° and a template of 270° are used for detecting the upper edge of the rectangle image, a template of 225° and a template of 180° are used for detecting the right edge of the rectangle image, and a template of 135° and a template of 90° are used for detecting the lower edge of the rectangle image.

After corresponding feature comparison templates are provided for any edge of the image, convolution of the feature comparison templates with image is performed to generate corresponding third functions, the result of convolution is grayscale values, then the grayscale values are compared with the central color feature values extracted in the step S102 and points, the grayscale values of which exceed the extracted central color feature values, are selected as candidate points. Specifically, for example, feature comparison templates of 8 directions shown in FIG. 5 are used to perform convolution with the image of the Life VC tag, respectively, to obtain the respective corresponding third functions. A relevant value of a certain specific point in the image of the Life VC tag is input into a corresponding third function and the grayscale value corresponding to the point can be obtained. The grayscale value is compared with the central color feature value (a: 0, b: 0, L: 69) of the image of the Life VC tag and points in the comparison result, which exceed the central color feature value, will be selected as candidate points.

After the multiple candidate points of each edge are extracted, a step S106 is performed of grouping the multiple candidate points corresponding to the edge according to distances and/or directions, so as to obtain multiple candidate point groups. The candidate points with similar distances and of the same direction relative to the edge are divided into one group. The grouping is performed according to this rule and each edge at least corresponds to a group of candidate points. The corresponding multiple candidate points are grouped, so that the candidate points, which are distributed dispersedly, present a certain regularity, and according to the presented regularity, it is beneficial to fitting of a fit line corresponding to the edge, to improve the quality of the candidate fit line and further to increase the accuracy of the image edge location.

According to the grouping of the extracted candidate points, a step S108 is performed of fitting a corresponding fit line by using candidate points in each candidate point group. That is, according to the grouping in the step S106, the candidate points in each group are fitted into a fit line in accordance with the presented regularity. Each edge of the image in the natural background at least corresponds to one fit line. For example, adjacent to the right edge of the image of the Life VC tag, 4 fit lines are fitted, in which only one fit line is a fit line corresponding to the right edge of the image of the Life VC tag, and other 3 fit lines may include fit lines corresponding to edges appearing in the image itself of the Life VC tag and may also include fit lines corresponding to edges appearing in the natural background. According to fitting degree of the fit lines with the edge of the image, one fit line is selected as the edge of the image, wherein the fitting degree includes the length of the fit line and that of the edge of the image being approximately equal, or the distance from the fit line to the edge of the image being closest, or the tilt angle of the fit line and that of the edge of the image being consistent, etc.

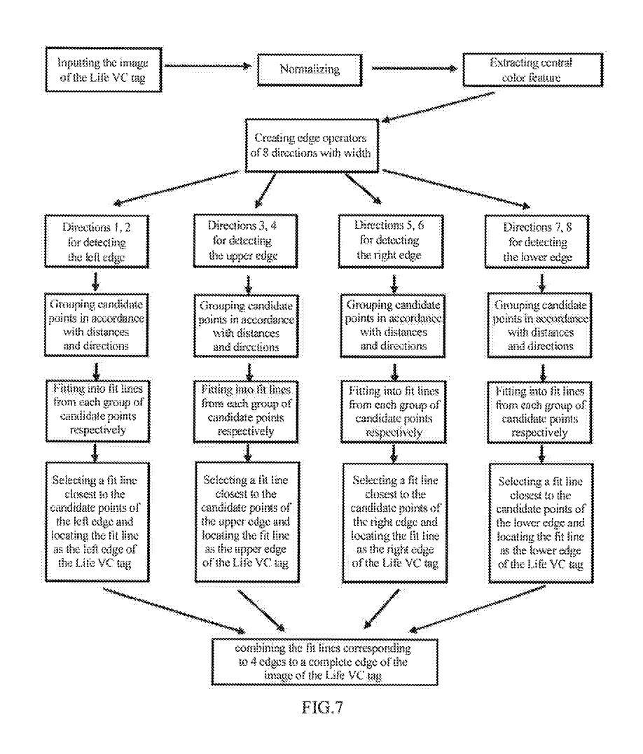

It should be noted that, if the traditional edge detection methods are used, because there may be disturbance of straight line of edges in the natural background, fit lines generated for the right edge of the image of the Life VC tag are more than 4. This is because computation of two dimensional confidence are performed for all of the edge points in the image and the natural background in the present invention, which include computation of dimension 1, that is, computation of a distance chart from an edge point to the central axis, and computation of dimension 2, that is, computation of similarity of the inside of the edge with the color of the foreground. FIG. 6 shows a schematic diagram of a model for computing a two dimensional confidence of an edge point of an embodiment of the present invention. With reference to FIG. 6, variables x, y of the model plane represent color and position of an edge point and z coordinate of the model represents the computed value f(x, y) of the two dimensional confidence. Such value is used to determine whether the edge point is an edge point in the natural background, so that the disturbance of most of edge lines in the natural background is avoided.

Because fit lines corresponding to each edge of the image in the natural background are at least one, it needs to select a fit line closest to the candidate points of the edge and locate the fit line as the edge in accordance with a step S110. Specifically, for example, there are 4 fit lines adjacent to the right edge of the Life VC tag, a fit line with the largest number of candidate points is selected by comparing the numbers of the candidate points included in the 4 fit lines and the fit line is used as the right edge of the Life VC tag. The way to determine the fit line of other 3 edges of the Life VC tag is similar to that of the right edge and will not be repeated here.

To sum up, according to the method in an embodiment of the present invention, the central color feature of an image is extracted as a comparison standard. Due to the centrality of the central color feature, the relation of each edge to the center is made relatively comply with the average, for example, the distance or the direction from a comparison feature point to each edge is more consistent, so that the obtained candidate points of each edge maintain smoothness, candidate points with larger error will not occur easily, and the influence of the natural background on the central color feature can be avoided as much as possible. For example, if the comparison feature points are close to a certain edge and the color of the natural background near the edge is close to the color of the comparison feature points, it easily leads to blurred lines. Therefore, by using the central color feature, the natural background and the image can be divided as much as possible, multiple kinds of disturbances of the natural background (such as color disturbance or noise disturbance) can be avoided, and the accuracy of the image edge location can be improved. In addition, by extracting the candidate points by comparing with the central line color feature, in comparison with the traditional edge detection method, the amount of the computation of the executive body is reduced and the speed of the image edge location is increased. By grouping the multiple candidate points corresponding to the edge according to the distance and/or the direction, the candidate points, which are distributed dispersedly, present a certain regularity, and according to the presented regularity, it is beneficial to fitting of a fit line corresponding to the edge, to improve the quality of the candidate fit line and further to increase the accuracy of the image edge location.

In a preferable embodiment of the present invention, if location operation has been completed for each edge in the image, at least the following steps further need to be performed:

combining the selected fit lines corresponding to each edge to generate the complete edge of the image. For example, after corresponding fit lines have been fitted for 4 edges of upper, lower, left and right of the image of the Life VC tag in accordance with the method in the present invention, these 4 fit lines are combined to obtain the complete edge of the image of the Life VC tag.

It should be noted that, because the image comes from different sources, for example may be shot by using different terminal devices or by selecting different shooting modes by the same terminal device, it results in different feature parameters of the image (such as format of the picture, size of the picture and luminance and grayscale of the picture, etc.), which makes the location process of the image edges difficult. Therefore, in a preferable embodiment of the present invention, before extracting the central color feature serving as the comparison standard for the image located in the natural background, at least the following features will be further performed:

performing normalizing process on the image to convert the image into a standard format that can be processed. For example, the image is converted into a unified format (such as jpg), or gray balance processing is performed on the image, or the size of the image is scaled to a standard size (such as 384*288), and so on. After the normalizing process is performed on the image, the image is made have a unified standard format, which is beneficial to perform location process of the image edges in accordance with of the method of the present invention by the executive body.

If the image in the natural background is a rectangle and there is an angle between the image and the vertical direction, in a preferable embodiment of the present invention, the complete edge is adjusted according to the angle until the angle between the complete edge and the vertical direction disappears. For example, if rotation or stereo rotation occurs in the placement of the image, then before performing location process of the image edges, on the one hand the angle of the feature comparison template can be adjusted, that is, the angle of the edge operator with width is correspondingly adjusted according to the angle of the image, on the other hand by using method of space grid correction, the original image can also be divided into geometric grids and mapped into geometric grids of a model image grid by grid, to obtain an image having a complete edge with zero angle difference relative to the vertical direction.

The operation steps and beneficial effects of the method for locating the image edge in the natural background provided by the present invention will be further explained by using the image of the Life VC tag as a specific embodiment of the present invention below. FIG. 7 shows a schematic diagram of a process flow of a method for locating the image edge of the Life VC tag according to an embodiment of the present invention.

First of all, the image of the Life VC tag is input into the executive body, normalizing process is performed on the image of the Life VC tag and the image is converted into a standard format, for example, grey balance processing is performed on the image of the Life VC tag and the size of the image is adjusted to 384*288 and so on. Then the image of the Life VC tag is scanned by using a camera, the central position of the Life VC tag is detected, relevant information on the color of the central position of the image is acquired, the relevant information on the color is input into the model shown in FIG. 2 and a central color feature value (a: 0, b: 0, L: 69) of the image is obtained according to the model. Due to the centrality of the central color feature of the image of the Life VC tag, the relations of 4 edges to the center relatively are made comply with the average, so that the candidate points of 4 edges obtained below according to comparison with the central color feature maintain smoothness and candidate points with larger error will not occur easily. If a color feature of another position is used as the comparison standard, due to inconsistent distance and direction from the respective 4 edges to the comparison feature point, a case may emerge in which the candidate points of each edge obtained by comparison may have larger errors. Further, due to the centrality of the central color feature in the image, the influence of the natural background on the central color feature can be avoided as much as possible. Therefore, by using the central color feature, the natural background and the Life VC tag can be divided as much as possible, multiple kinds of disturbances of the natural background (such as color disturbance or noise disturbance) can be avoided, and the accuracy of the image edge location can be improved.

The image of the Life VC tag includes 4 edges of upper, lower, left and right and edge operators of 8 directions with widths shown in FIG. 5 are provided for these 4 edges, in which a template of 0° and a template of 45° are used for detecting the left edge of the image of the Life VC tag, a template of 315° and a template of 270° are used for detecting the upper edge of the rectangle image of the Life VC tag, a template of 225° and a template of 180° are used for detecting the right edge of the image of the Life VC tag, and a template of 135° and a template of 90° are used for detecting the lower edge of the image of the Life VC tag.

Then convolution with the image of the Life VC tag is performed by using the feature comparison templates of 8 directions shown in FIG. 5, respectively, to obtain third functions corresponding to the respective edges. A relevant value of a certain specific point in the image of the Life VC tag is input into a corresponding third function and a grayscale value corresponding to the point can be obtained. The grayscale value is compared with the central color feature value (a: 0, b: 0, L: 69) of the image of the Life VC tag and points in the comparison result, the grayscale values of which exceed the central color feature value, are selected as candidate points. In comparison with the traditional edge detection method, by extracting the candidate points by using the comparison with the central line color feature in the present invention, the amount of the computation of the executive body is reduced and the speed of the image edge location is increased.

The candidate points with similar distances and of the same direction relative to each edge of the image of the Life VC tag are divided into one group, to obtain candidate point groups corresponding to 4 edges of the Life VC tag. The grouping is performed according to this rule, so that the candidate points, which are distributed dispersedly, present certain regularity, and according to the presented regularity, it is beneficial to fitting of fit lines corresponding to the edges, so as to improve the quality of the candidate fit lines.

At last, the candidate points in the respective candidate point groups corresponding to 4 edges of the Life VC tag are fitted into corresponding fit lines, a fit line closest to the candidate points of each edge is selected as a corresponding edge of the Life VC tag, and then the fit lines corresponding to the 4 edges are combined to generate a complete edge of the image of the Life VC tag.

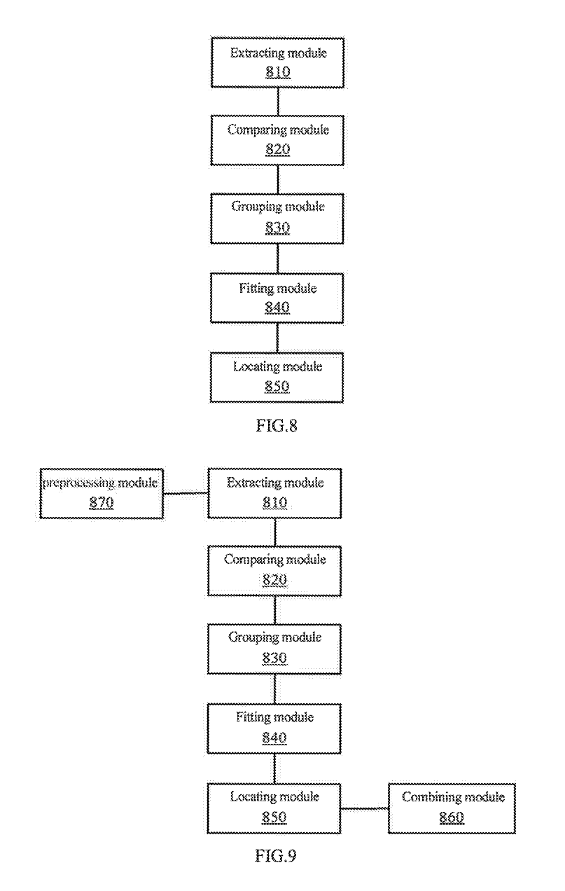

Based on the same inventive concept, a device for locating an image edge in a natural background is also provided in an embodiment of the present invention. FIG. 8 shows a schematic diagram of a structure of a device for locating the image edge in the natural background according to an embodiment of the present invention. With reference to FIG. 8, the device at least includes:

an extracting module 810 adapted for extracting a central color feature serving as a comparison standard for an image located in a natural background;

a comparing module 820 couple to the extracting module 810 and adapted for comparing with the central color feature and extracting multiple candidate points for each edge of the image according to a comparison result;

a grouping module 830 adapted for performing the following operation for each edge: grouping the multiple candidate points corresponding to the edge according to distances and/or directions, so as to obtain multiple candidate point groups;

a fitting module 840 coupled to the grouping module 830 and adapted for, for each edge, fitting a corresponding fit line by using candidate points in each candidate point group;

a locating module 850 coupled to the fitting module 840 and adapted for, for each edge, selecting a fit line closest to the candidate points of the edge and locating the fit line as the edge.

In a preferable embodiment, with reference to FIG. 9, the device for locating the image edge in the natural background may further include:

a combining module 860 coupled to the locating module 850 and adapted for, after location operation on each edge is completed, combining the selected fit lines corresponding to each edge to generate a complete edge of the image.

In a preferable embodiment, with reference to FIG. 9, the device for locating the image edge in the natural background may further include:

a preprocessing module 870 coupled to the extracting module 810 and adapted for performing normalizing process on the image to convert the image into a standard format that can be processed.

In a preferable embodiment, the extracting module 810 is further adapted for extracting a central color feature according to luminance L and color (a, b) of the image.

In a preferable embodiment, the comparing module 820 is further adapted for:

providing feature comparison templates for each edge of the image;

performing convolution with the image by using the feature comparison templates of any edge and comparing grayscale values obtained by convolution with the central color feature, and extracting points, the grayscale values of which exceed the central color feature as candidate points.

In a preferable embodiment, if the image is a rectangle, feature comparison templates of 8 directions are provided for the image, in which feature comparison templates of every two adjacent directions in combination are used for detecting one edge of the image.

Preferably, the above described feature comparison template is an edge operator with width. Wherein the width of the detected edge is about half width of the edge operator.

In a preferable embodiment, the preprocessing module 870 is further adapted for: if the image is a rectangle and there is an angle between the image and the vertical direction, the complete edge is adjusted according to the angle until the angle between the complete edge and the vertical direction disappears.

To sum up, the following beneficial effects can be achieved by using the method and the device for locating the image edge in the natural background provided in the embodiment of the present invention:

According to the method in an embodiment of the present invention, the central color feature of an image is extracted as a comparison standard. Due to the centrality of the central color feature, the relation of each edge to the center is made relatively comply with the average, for example, the distance or the direction from a comparison feature point to each edge is more consistent, so that the obtained candidate points of each edge maintain smoothness, candidate points with larger error will not occur easily, and the influence of the natural background on the central color feature can be avoided as much as possible. For example, if the comparison feature points are close to a certain edge and the color of the natural background near the edge is close to the color of the comparison feature points, it easily leads to blurred lines. Therefore, by using the central color feature, the natural background and the image can be divided as much as possible, multiple kinds of disturbances of the natural background (such as color disturbance or noise disturbance) can be avoided, and the accuracy of the image edge location can be improved. In addition, by extracting the candidate points by comparing with the central line color feature, in comparison with the traditional edge detection method, the amount of the computation of the executive body is reduced and the speed of the image edge location is increased. By grouping the multiple candidate points corresponding to the edge according to the distance and/or the direction, the candidate points, which are distributed dispersedly, present a certain regularity, and according to the presented regularity, it is beneficial to fitting of a fit line corresponding to the edge, to improve the quality of the candidate fit line and further to increase the accuracy of the image edge location.

The description provided here explains plenty of details. However, it can be understood that the embodiments of the disclosure can be implemented without these specific details. The known methods, structure and technology are not shown in detail in some embodiments, so as not to obscure the understanding of the description.

Similarly, it should be understood that in order to simplify the disclosure and help to understand one or more of the various aspects of the disclosure, the various features of the disclosure are sometimes grouped into a single embodiment, drawing, or description thereof. However, the method disclosed should not be explained as reflecting the following intention: that is, the disclosure sought for protection claims more features than the features clearly recorded in every claim. To be more precise, as is reflected in the following claims, the aspects of the disclosure are less than all the features of a single embodiment disclosed before. Therefore, the claims complying with a specific embodiment are explicitly incorporated into the specific embodiment thereby, wherein every claim itself as an independent embodiment of the disclosure.

Those skilled in the art can understand that adaptive changes can be made to the modules of the devices in the embodiment and the modules can be installed in one or more devices different from the embodiment. The modules or units or elements in the embodiment can be combined into one module or unit or element, and furthermore, they can be separated into more sub-modules or sub-units or sub-elements. Except such features and/or process or that at least some in the unit are mutually exclusive, any combinations can be adopted to combine all the features disclosed by the description (including the attached claims, abstract and figures) and any method or all process of the device or unit disclosed as such. Unless there is otherwise explicit statement, every feature disclosed by the present description (including the attached claims, abstract and figures) can be replaced by substitute feature providing the same, equivalent or similar purpose.

In addition, a person skilled in the art can understand that although some embodiments described here comprise some features instead of other features included in other embodiments, the combination of features of different embodiments means falling into the scope of the disclosure and forming different embodiments. For example, in the following claims, any one of the embodiments sought for protection can be used in various combination modes.

The various components embodiments of the disclosure can be realized by hardware, or realized by software modules running on one or more processors, or realized by combination thereof. A person skilled in the art should understand that microprocessor or digital signal processor (DSP) can be used for realizing some or all functions of some or all components of device for locating the image edge in the natural background according to the embodiments in the disclosure in practice. The disclosure can also realize one part of or all devices or system programs (for example, computer programs and computer program products) used for carrying out the method described here. Such programs for realizing the disclosure can be stored in computer readable medium, or can possess one or more forms of signal. Such signals can be downloaded from the Internet website or be provided at signal carriers, or be provided in any other forms.

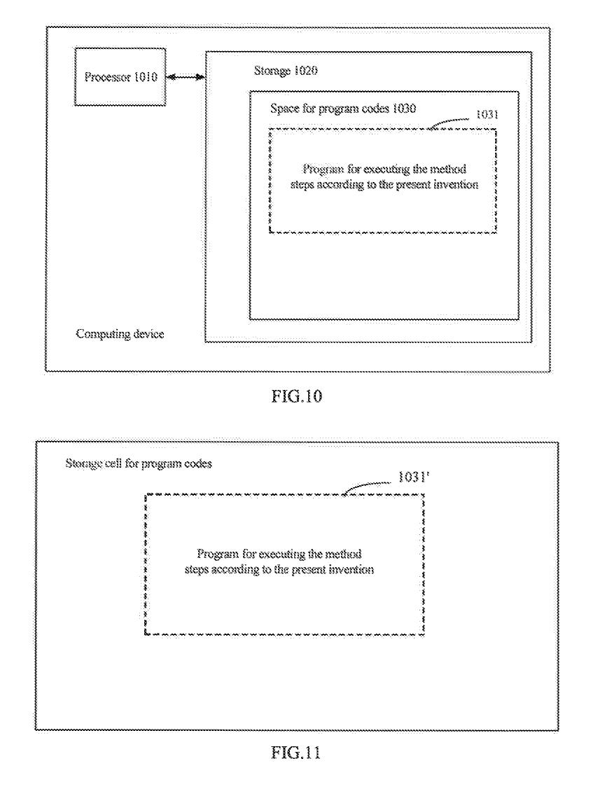

For example, FIG. 10 shows a computing device by which the method for locating the image edge in the natural background according to the disclosure can be implemented. The computing device traditionally comprises a processor 1010 and a computer program product in the form of storage 1020 or a computer readable medium. The storage 1020 can be electronic storage such as flash memory, EEPROM (Electrically Erasable Programmable Read -Only Memory), EPROM, hard disk or ROM, and the like. The storage 1020 possesses storage space 2630 for carrying out program code 1031 of any method steps of the aforesaid method. For example, storage space 1030 for program code can comprise various program codes 1031 used for respectively realizing various steps of the aforesaid method. These program codes can be read out from one or more computer program products or write in one or more computer program products. The computer program products comprise program code carriers such as hard disk, Compact Disc (CD), memory card or floppy disk and the like. These computer program products usually are portable or fixed storage cell as the in FIG. 11. The storage cell can possess memory fields, storage space arranged like the storage 1020 in the computing device in FIG. 10. The program code can be compressed in, for example, a proper form. Generally, storage cell comprises computer readable code 1031′, i.e. the code can be read by processors such as 1010 and the like. When the codes run on a computer device, the computer device will carry out various steps of the method described above.

The “an embodiment”, “embodiments” or “one or more embodiments” referred here mean being included in at least one embodiment in the disclosure combining specific features, structures or characteristics described in the embodiments. In addition, please note that the phrase “in an embodiment” not necessarily mean a same embodiment.

It should be noticed that the embodiments are intended to illustrate the disclosure and not limit this disclosure, and a person skilled in the art can design substitute embodiments without departing from the scope of the appended claims. In the claims, any reference marks between brackets should not be constructed as limit for the claims. The word “comprise” does not exclude elements or steps that are not listed in the claims. The word “a” or “one” before the elements does not exclude that more such elements exist. The disclosure can be realized by means of hardware comprising several different elements and by means of properly programmed computer. In the unit claims several devices are listed, several of the systems can be embodied by a same hardware item. The use of words first, second and third does not mean any sequence. These words can be explained as name.

In addition, it should be noticed that the language used in the disclosure is chosen for the purpose of readability and teaching, instead of for explaining or limiting the topic of the disclosure. Therefore, it is obvious for a person skilled in the art to make a lot of modification and alteration without departing from the scope and spirit of the appended claims. For the scope of the disclosure, the disclosure is illustrative instead of restrictive. The scope of the disclosure is defined by the appended claims.

What is claimed is:

1. A method for locating an image edge in a natural background, comprising:
extracting a central color feature serving as a comparison standard for an image located in a natural background;
comparing with the central color feature and extracting multiple candidate points for each edge of the image according to a comparison result;
grouping the multiple candidate points corresponding to the edge according to distances and/or directions, so as to obtain multiple candidate point groups;
fitting corresponding fit lines by using the candidate points in each candidate point group;
selecting a fit line closest to the candidate points of the edge and locating the fit line as the edge.

2. The method according to claim 1, wherein after location operation on each edge is completed, the method further comprises: combining the selected fit lines corresponding to each edge to generate a complete edge of the image.

3. The method according to claim 1, wherein before extracting the
central color feature serving as the comparison standard for the image located in the natural background, the method further comprises:
performing normalizing process on the image to convert the image into a standard format that can be processed.

4. The method according to claim 1, wherein the extracting the central color feature serving as the comparison standard comprises: extracting the central color feature according to luminance L and color (a, b) of the image.

5. The method according to claim 1, wherein the
comparing with the central color feature and extracting multiple candidate points for each edge of the image according to the comparison result comprises:
providing feature comparison templates for each edge of the image;
performing convolution with the image by using the feature comparison templates of any edge and comparing grayscale values obtained by convolution with the central color feature to obtain the comparison result;
selecting and extracting points in the comparison result, the grayscale values of which exceed the central color feature, as candidate points.

6. The method according to claim 5, wherein if the image is a rectangle, feature comparison templates of 8 directions are provided for the image, in which feature comparison templates of every two adjacent directions in combination are used for detecting one edge of the image.

7. The method according to claim 5, wherein the feature comparison template is an edge operator with width.

8. The method according to claim 6, wherein the width of the detected edge is half width of the template.

9. The method according to claim 2, wherein the method further comprises:
if the image is a rectangle and there is an angle between the image and a vertical direction, the complete edge is adjusted according to the angle until the angle between the complete edge and the vertical direction disappears.

10. A device for locating an image edge in a natural background comprising:
an extracting module adapted for extracting a central color feature serving as a comparison standard for an image located in a natural background;
a comparing module adapted for comparing with the central color feature and extracting multiple candidate points for each edge of the image according to a comparison result;
a grouping module adapted for performing the following operation for each edge: grouping the multiple candidate points corresponding to the edge according to distances and/or directions, so as to obtain multiple candidate point groups;
a fitting module adapted for, for each edge, fitting corresponding fit lines by using the candidate points in each candidate point group;
a locating module adapted for, for each edge, selecting a fit line closest to the candidate points of the edge and locating the fit line as the edge.

11. The device according to claim 10, wherein the device further comprises:
a combining module adapted for, after location operation on each edge is completed, combining the selected fit lines corresponding to each edge to generate a complete edge of the image.

12. The device according to claim 10, wherein the device further comprises:
a preprocessing module adapted for performing normalizing process on the image to convert the image into a standard format that can be processed.

13. The device according to claim 10, wherein the extracting module is further adapted for extracting the central color feature according to luminance L and color (a, b) of the image.

14. The device according to claim 10, wherein the comparing module is further adapted for:
providing feature comparison templates for each edge of the image;
performing convolution with the image by using the feature comparison templates of any edge and comparing grayscale values obtained by convolution with the central color feature, and extracting points, the grayscale values of which exceed the central color feature as candidate points.

15. The device according to claim 10, wherein if the image is a rectangle, feature comparison templates of 8 directions are provided for the image, in which feature comparison templates of every two adjacent directions in combination are used for detecting one edge of the image.

16. The device according to claim 14, wherein the feature comparison template is an edge operator with width.

17. The device according to claim 15, wherein the width of the detected edge is half width of the template.

18. The device according to claim 12, wherein the preprocessing module is further adapted for:
if the image is a rectangle and there is an angle between the image and a vertical direction, the complete edge is adjusted according to the angle until the angle between the complete edge and the vertical direction disappears.

19. (canceled)

20. (canceled)
